(19) United States
(12) Patent Application Publication
(10) Pub. No.: US 2017/0351820 A1
(43) Pub. Date: Dec. 7, 2017

(54) SCHEDULING INTERACTION WITH A SUBJECT

(71) Applicant: KONINKLIJKE PHILIPS N.V., EINDHOVEN (NL)

(72) Inventors: Aart Tijmen VAN HALTEREN, Geldrop (NL); Sebastiaan Valentijn DEN BOER, Utrecht (NL); Jolijn TEUNISSE, Eindhoven (NL)

(21) Appl. No.: 15/541,385

(22) PCT Filed: Jan. 6, 2016
(86) PCT No.: PCT/EP2016/050112

§ 371 Date: Jul. 3, 2017

(30) Foreign Application Priority Data
Jan. 7, 2015 (EP) 15150268.9

(51) Int. Cl. G06F 19/00; G06Q 10/10; G06N 5/02

(52) U.S. Cl. CPC G06F 19/327; G06N 5/022; G06Q 10/1093

(57) ABSTRACT

The present invention relates to a scheduling system (2) for scheduling interaction with a subject (3). A receiving unit (6) receives sensor data acquired by one or more sensors (4, 5), wherein the sensor data are indicative of a situation of the subject. An analyzing unit (6) analyses the received sensor data for a past period of time to detect recurring patterns in the situation of the subject during the past period of time. A predicting unit (7) predicts the situation of the subject during a future period of time based on the received sensor data for a current period of time and the detected recurring patterns. A scheduling unit (9) generates a schedule for interacting with the subject based on the predicted situation. By utilizing the predicted situation to generate a schedule for interacting with the subject, it is possible to identify opportune moments for interacting with the subject.

### FIELD OF THE INVENTION

The present invention relates to a scheduling system, a scheduling method and a scheduling computer program for scheduling interaction with a subject. The present invention relates further to an interaction system for interacting with a subject, which comprises the scheduling system.

### BACKGROUND OF THE INVENTION

An unhealthy lifestyle is considered to be one of the root causes of chronic medical conditions. For instance, it has been shown in studies that unhealthy habits can lead to more and/or greater illness and more and/or longer hospitalization. In order to improve their conditions, patients are often required to change one or more of their lifestyle habits and/or behaviors. However, it has also been found in studies that changing unhealthy habits is often not straightforward and that maintaining changes in behavior can indeed be quite challenging for the patient.

Considering the automatic, powerful and context-driven nature of habits, it is quite understandable that they are hard to change. Thus, it is desirable in many cases that patients are supported in their efforts to change, for instance, by interactions from a medical caregiver. Studies have shown that for influencing a patient's health behavior, the timing of the interactions with the patient is important. Delivering the right information at the wrong time is not very effective. Thus, there is a need for a system that is able to identify opportune moments for interacting with a patient.

US 2004/0003042 A1 relates to a system and methodology to facilitate collaboration and communications between entities such as between automated applications, parties to a communication and/or combinations thereof. The disclosed systems and methods include a service that supports collaboration and communication by learning predictive models that provide forecasts of one or more aspects of a user's presence and availability. Presence forecasts include a user's current or future locations at different levels of location precision and usage of different devices or applications. Availability assessments include inferences about the cost of interrupting a user in different ways and a user's current or future access to one or more communication channels. The predictive models are constructed from data collected by considering user activity and proximity from multiple devices, in addition to analysis of the content of users' calendars, the time of day, and day of week, for example.

### SUMMARY OF THE INVENTION

It is an object of the present invention to provide a scheduling system, a scheduling method and a scheduling computer program for scheduling interaction with a subject, which allow identifying opportune moments for interacting with a subject. It is a further object of the present invention to provide an interaction system for interacting with a subject, which comprises the scheduling system.

In a first aspect of the present invention, a scheduling system for scheduling interaction with a subject is presented, wherein the scheduling system comprises:
a receiving unit adapted to receive sensor data acquired by one or more sensors, wherein the sensor data are indicative of a situation of the subject,
an analyzing unit adapted to analyze the received sensor data for a past period of time to detect recurring patterns in the situation of the subject during the past period of time,
a predicting unit adapted to predict the situation of the subject during a future period of time based on the received sensor data for a current period of time and the detected recurring patterns, and
a scheduling unit adapted to generate a schedule for interacting with the subject based on the predicted situation,

wherein the analyzing unit is adapted to represent the situation of the subject by a readiness measure which indicates a readiness of the subject to process information at a given time, wherein the analyzing unit is adapted to determine the readiness measure for the past period of time based on the received sensor data for the past period of time and to detect the recurring patterns in the readiness measure for the past period of time, wherein the predicting unit is adapted to predict the readiness measure for the future period of time based on the received sensor data for the current period of time and the detected recurring patterns.

By analyzing the received sensor data for a past period of time, the analyzing unit can detect recurring patterns in the situation of the subject during the past period of time. The detected recurring patterns can then be utilized by the predicting unit to predict the situation of the subject during a future period of time based on the received sensor data for a current period of time. Since the scheduling unit utilizes the predicted situation to generate a schedule for interacting with the subject, it is possible for the scheduling unit to identify opportune moments for interactions.

The subject is preferably a medical subject, i.e., a patient, in particular, a patient having a chronic medical condition, i.e., a health condition or disease that is persistent or otherwise long-lasting in its effects or a disease that comes with time. For example, the World Health Organization classifies a medical condition as chronic if it lasts for more than three months. Some well-known examples of chronic medical conditions include mental illnesses, diabetes mellitus, hypertension, epilepsy, Alzheimer's disease, Parkinson's disease, et cetera.

The past period of time can be, for instance, a number of days, a number of weeks or even a number of months. In general, it is preferred for the past period of time to be comparably long in order to have sufficient sensor data available for allowing the analyzing unit to perform a robust and high-quality detection of the recurring patterns in the situation of the subject during the past period of time.

The analyzing unit preferably analyses the received sensor data for the past period of time in certain units of time, for instance, in units of days. In this case, the situation of the subject on each day of the past period of time may be compared in order to find recurring patterns in the daily situation of the subject during the past period of time. Of course, patterns that only recur on a coarser temporal basis, for instance, on a weekly basis or every 14 days, may also be considered in the analysis.

The detected recurring patterns in the situation of the subject can be thought of as “recurring situations”, which are experienced by the subject on a recurring basis.

The schedule which is generated by the scheduling unit preferably comprises at least one time at which it is considered to be opportune to interact with the subject. For instance, the generated schedule may indicate the period of time from 2 pm to 5 pm on the present day as being an opportune period of time for interacting with the subject.

It shall be understood that the situation of the subject, as used herein, can be influenced by a behavior of the subject and/or an environment of the subject, preferably, by both of the behavior and the environment, as will exemplarily be explained in more detail below.

The different units of the scheduling system can be provided together, i.e., the scheduling system can consist of only local units, which are provided in the sphere of the subject, or they can be spatially distributed, i.e., the scheduling system can consist of local units, which are provided in the sphere of the subject, and remote units, which are provided in the sphere of, for instance, a medical caregiver, such as a medical doctor, a nurse or a pharmacist, who would like to interact with the subject. For example, in one possible configuration, the receiving unit, the analyzing unit, the predicting unit and the scheduling unit are all provided in the sphere of the subject. In this case, the generated schedule may be transmitted to a medical caregiver by means of a suitable transmission technology, such as a technology based on today's internet standards, mobile communication standards or the like. In another possible configuration, the receiving unit, the analyzing unit, the predicting unit and the scheduling unit can all be provided in the sphere of a medical caregiver. In this case, only the one or more sensors may be provided in the sphere of the subject and the one or more sensors may transmit the acquired sensor data to the receiving unit at the medical caregiver. Of course, also combinations of these two extremes are possible. For instance, the receiving unit, the analyzing unit and the predicting unit can be provided in the sphere of the subject and the scheduling unit can be provided in the sphere of a medical caregiver. In this case, the predicted situation may be transmitted to the medical caregiver, where the scheduling unit generates the schedule based on the received predicted situation.

It is preferred that the analyzing unit is adapted to detect the recurring patterns based on eigensituations derived from the received sensor data for the past period of time, wherein the eigensituations characterize the situational variation during the past period of time. A related approach is described in detail in Nathan Eagle and Alex Sandy Pentland, “Eigenbehaviors: identifying structure in routine”, in Behavioral Ecology and Sociobiology, Vol. 63, No. 11, pages 1057 to 1066, April 2009, the contents of which are herein incorporated in their entirety. Their concept is based on the recognition that behavioral data generally contains a significant amount of structure and that this behavioral structure can be represented by a weighted sum of the principle components of the complete behavioral dataset, a set of characteristic vectors the authors have termed “eigenbehaviours”. In the mentioned paper, eigenbehaviours, i.e., the set of characteristic vectors that span the ‘behavioral space’ and, thus, characterize the behavioral variation during the past period of time, are used to predict a future location of an individual (i.e., at work, at home, et cetera) based on location data acquired by the individual's mobile phone over the course of nine months. In the present invention, a modified version of the concept of eigenbehaviours is used for representing and analyzing the ‘situational space’ resulting from the received sensor data for the past period of time by its “eigensituations”, i.e., the principal components of the situational dataset.

As mentioned above, the analyzing unit is adapted to represent the situation of the subject by a readiness measure which indicates a readiness of the subject to process information at a given time. The effectiveness of an interaction with the subject depends to a significant degree on the subject's readiness to process information at the moment the interaction is initiated and/or performed. Thus, by representing the situation of the subject by a readiness measure which indicates a readiness of the subject to process information at a given time, it is possible to identify opportune moments for interacting with a patient based on the predicted situation of the subject during the future period of time, i.e., based on his/her predicted readiness to process information during the future period of time.

It is further preferred that the sensor data comprise biometric data of the subject acquired by one or more biometric sensors and environmental data of an environment of the subject acquired by one or more environmental sensors, wherein the readiness measure for the past period of time is determined from the received biometric data for the past period of time and the received environmental data for the past period of time. By making use of both biometric data for the past period of time and environmental data for the past period of time, the readiness measure for the past period of time can be determined with a high reliability.

For instance, in one possible configuration, the biometric data preferably comprise one or more of data indicative of an activity level of the subject and data indicative of a relaxation level of the subject, and the environmental data preferably comprise one or more of data indicative of a location of the subject, data indicative of an air quality in the environment of the subject, and data indicative of a presence of persons nearby the subject. The sensor data can be acquired, for example, by means of an accelerometer (activity level), which acquires an acceleration of the subject, a heart rate monitor (relaxation level), which acquires a heart rate of the subject, a GPS sensor (location), which acquires the location of the subject, a CO₂ sensor (air quality), which acquires an amount of CO₂ in the environment of the subject, and a Bluetooth device (presence of persons nearby the subject), which acquires a presence of Bluetooth devices nearby the subject. The received sensor data for the past period of time can be further processed, for instance, classified or the like. In one example, the activity level of the subject is determined from the acquired acceleration, wherein the determined activity level is classified into a number of classes, e.g., <low activity level>, <medium activity level>, <high activity level>. Likewise, the relaxation level, the location, the air quality and the presence of persons nearby the subject can be determined from the acquired sensor data, respectively, and the determined parameters can be classified into a number of classes. For instance, suitable classes could be chosen as: <low relaxation level>, <medium relaxation level>, <high relaxation level> for the relaxation level; <indoor>, <outdoor> for the location; <good air quality>, <medium air quality>, <high air quality> for the air quality; <no persons present>, <persons present> for the presence of persons nearby the subject. It shall be noted that in addition to the sensor data additional information, for example, predetermined knowledge about the subject, can be used for determining the different parameters. For instance, in order to determine the location of the subject, in addition to the location acquired by the GPS sensor, predetermined knowledge about the location of the subject's home and/or the subject's workplace can be used for determining whether the subject is located indoor or outdoor at a given time. Moreover, other classifications may be used, for instance, the presence of persons nearby the subject may be classified less coarsely in <no persons present>, <less than 2 persons present>, <less than five persons present>, <five or more persons present>. It is to be understood that, in general, a finer classification may be preferable, provided that the additional detail in the classification allows for a more precise and/or more robust determination of the readiness measure.

In this example, the determined activity level, relaxation level, location, air quality and presence of persons nearby the subject are preferably used by the analyzing unit to reliably determine the readiness measure for the past period of time. For instance, in one preferred realization, the determined parameters are combined in a sum or a weighted sum to determine the readiness measure for the past period of time. In more detail, different scores may be given to the respective classes of the different parameters and, for a given time during the past period of time, the readiness measure may be determined by summing the scores for the sensor data for the given time. In this approach, it is preferred that the scores are suitably chosen such that parameters that are considered to have a stronger influence on the subject's readiness to process information are generally given larger scores than parameters that are considered to have a weaker influence. The scores can be chosen, for example, such that a higher readiness measure indicates a higher readiness of the subject to process information, whereas a lower readiness measure indicates a lower readiness of the subject to process information. The readiness measure may be further classified based on the sum of the scores into a number of classes, e.g., <low readiness>, <medium readiness>, <high readiness>.

As mentioned above, the analyzing unit is adapted to determine the readiness measure for the past period of time based on the received sensor data for the past period of time and to detect the recurring patterns in the readiness measure for the past period of time, wherein the predicting unit is adapted to predict the readiness measure for the future period of time based on the received sensor data for the current period of time and the detected recurring patterns.

For instance, in one possible realization, an eigensituation analysis is performed on the readiness measure for the past period of time in order to determine the eigensituations, i.e., the set of characteristic vectors that span the ‘situational space’, which characterize the situation variation, here, the variation in the readiness of the subject to process information, during the past period of time. The analysis can be performed in units of days, in which case the eigensituations characterize the daily variation in the readiness of the subject to process information during the past period of time. The strongest or primary eigensituations correspond to the recurring patterns in the daily situation (e.g., the readiness to process information) of the subject during the past period of time (see Nathan Eagle and Alex Sandy Pentland, “Eigenbehaviors: identifying structure in routine”, in Behavioral Ecology and Sociobiology, Vol. 63, No. 11, pages 1057 to 1066, April 2009). The recurring patterns can be used to “analyze” the received sensor data for the current period of time and to predict the readiness measure for the future period of time. As described above, the biometric data exemplarily comprises the data indicative of the activity level of the subject and the data indicative of the relaxation level of the subject and the environmental data exemplarily comprises the data indicative of the location of the subject, the data indicative of the air quality in the environment of the subject and the data indicative of the presence of persons nearby the subject. The received sensor data for the current period of time can be further processed, for instance, classified or the like, as described above, in order for the analyzing unit to determine the activity level of the subject, the relaxation level of the subject, the location of the subject, the air quality in the environment of the subject and the presence of persons nearby the subject, wherein these parameters can then be used to reliably determine the readiness measure for the current period of time. By calculating the weights for the recurring patterns such that their weighted sum suitably represents the readiness measure for the current period of time, the readiness measure for the current period of time can then be predicted.

It is preferred that the scheduling unit is adapted to generate the schedule based on the predicted readiness measure for the future period of time. As already mentioned above, by basing the generation of the schedule on the subject's predicted readiness to process information during the future period of time, it is possible to identify opportune moments for interacting with a patient. For instance, in the example described above, an interaction with the subject may be scheduled for a time during the future period of time for which the predicted readiness measure assumes a <high readiness>.

It is further preferred that the current period of time corresponds to a first part of a present day and the future period of time corresponds to a later part of the present day. For instance, the current period of time can correspond to the first half of the present day, i.e., from 12 am to 12 pm, and the future period of time can correspond to the second half of the present day, i.e., from 12 pm to 12 am. It is then possible for the predicting unit to predict the situation (e.g., the readiness to process information) of the subject during the second half of the day based on the received sensor data for the first half of the present day and the detected recurring patterns. The scheduling unit can then generate the schedule for interacting with the subject in the second half of the day based on the predicted situation of the subject during this (yet future) period of time. The first part of the present day does not have to be a continuous part but can also consist of a number of discontinuous sub-parts, for instance, from 12 am to 4 am and from 8 am to 12 pm. The same holds true also for the later part of the present day, i.e., it can, for instance, be from 2 pm to 4 pm and from 6 pm to 8 pm.

It is preferred that the analyzing unit is adapted to update the detection of the recurring patterns when additional sensor data for a more recent period of time compared to the past period of time have been received. This allows the analyzing unit to make use of as much received sensor data as possible for detecting the recurring patterns, which will result in an improved detection, in particular, of smaller and less frequently occurring patterns, over time. For instance, in case that the analyzing unit analyses the received sensor data in units of days, the detection of the recurring patterns may be updated on a daily basis when the sensor data for the past day have been received.

It is also preferred that the scheduling system further comprises the one or more sensors for acquiring the sensor data.

In a further aspect of the present invention, an interaction system for interacting with a subject is presented, wherein the interaction system comprises:
the scheduling system as defined in any of claims 1 to 6, and
an interaction sub-system for interacting with the subject.

It is preferred that the interaction sub-system comprises a system for performing a video conversation with the subject and/or a system for presenting media content to the subject. The media content preferably comprises moving picture content and/or still picture content and/or audio content and/or text content. A video conversation with the subject can be an effective means for influencing the subject in changing his/her behavior, since it allows for a direct, personal contact with, for instance, a medical caregiver, such as a medical doctor, a nurse or a pharmacist. In addition or alternatively, the possibility to present media content to the subject can allow for the presentation of educational media content, for instance, media content which illustrates how certain exercises that may improve or at least stabilize a medical condition of the subject should be performed, media content which illustrates how a medication should be taken, et cetera, to the subject. The media content can comprise moving picture content, still picture content, audio content or text content, or any combination of these elements. For instance, the illustration of an exercise may include a video, i.e., moving picture content, together with a descriptive text. Additionally, the exercise may be verbally explained, i.e., the illustration may further include audio content. In an exemplary alternative, the same exercise could be illustrated by means of a number of still pictures, for instance, a number of photographs or a number of illustrative graphical elements (similar to those shown on fitness studio equipment to explain the exercises performed with the equipment), which explain the exercise.

It is further preferred that the interaction sub-system is adapted to send a message to the subject for prompting the subject to engage in an interaction. It has been found that the opportunity for interacting efficiently with a subject, in particular, a patient is quite limited. Prompting the subject to engage in an interaction, for instance, to watch or hear educational media content or to take part in a video conversation with a medical caregiver, is an effective way to engage the subject. Indeed, it has been found by one of the present inventors in a study on “sitting behavior” that the sending of a persuasive message, i.e., a prompt, can be more effective in changing behavior than the actual content of information which the participants of the study could pull from a website (see Saskia van Dantzig, Gijs Geleijnse, and Aart Tijmen van Halteren, “Toward a persuasive mobile application to reduce sedentary behavior”, in Personal and Ubiquitous Computing, Vol. 17, No. 6, pages 1237 to 1246, August 2013).

It is preferred that the interaction sub-system is adapted to automatically initiate an interaction with the subject according to the generated schedule. Therewith, an automatic interaction sub-system can be realized which initiates an interaction with the subject at an opportune moment. For instance, the interaction sub-system can automatically present educational media content to the subject without requiring a medical caregiver to initiate and perform an interaction.

It is further preferred that the interaction sub-system is adapted to allow the subject to refuse the initiated interaction, wherein the interaction sub-system is further adapted to automatically re-initiate an interaction with the subject at a later time according to the generated schedule. This takes into consideration that, in some cases, the moment at which an interaction is initiated according to the generated schedule may indeed not be a good moment for interacting with the subject, for instance, because the situation of the subject on the present day strongly deviates from his/her “recurring situations”, such that the predicted situation is actually inaccurate, or because even though the predicted situation is reasonably accurate, something exceptional happened, which makes it inconvenient for the subject to engage in an interaction. In this case, the possibility of interacting with the subject must not be completely missed, but it can be tried again to initiate an interaction with the subject at a later time according to the generated schedule.

In a further aspect of the present invention, a computer-implemented scheduling method for scheduling interaction with a subject is presented, wherein the scheduling method comprises:
receiving sensor data acquired by one or more sensors, by a receiving unit, wherein the sensor data are indicative of a situation of the subject,
analyzing the received sensor data for a past period of time to detect recurring patterns in the situation of the subject during the past period of time, by an analyzing unit,
predicting the situation of the subject during a future period of time based on the received sensor data for a current period of time and the detected recurring patterns, by a predicting unit, and
generating a schedule for interacting with the subject based on the predicted situation, by a scheduling unit,

wherein the analyzing unit represents the situation of the subject by a readiness measure which indicates a readiness of the subject to process information at a given time, wherein the analyzing unit determines the readiness measure for the past period of time based on the received sensor data for the past period of time and to detect the recurring patterns in the readiness measure for the past period of time, wherein the predicting unit predicts the readiness measure for the future period of time based on the received sensor data for the current period of time and the detected recurring patterns.

In a further aspect of the present invention, a scheduling computer program for scheduling interaction with a subject is presented, wherein the scheduling computer program comprises program code means for causing a scheduling system as defined in any of claims 1 to 6 to carry out the steps of the scheduling method as defined in claim 12, when the scheduling computer program is run on a computer controlling the scheduling system.

It shall be understood that the scheduling system of claim 1, the interaction system of claim 7, the scheduling method of claim 12, and the scheduling computer program of claim 13 have similar and/or identical preferred embodiments, in particular, as defined in the dependent claims.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the drawings:

FIG. 1 shows schematically and exemplarily an embodiment of an interaction system for interacting with a subject,

FIG. 2 shows schematically and exemplarily a processing by the analyzing unit and the predicting unit using an eigensituation analysis, and

FIG. 3 shows a flowchart exemplarily illustrating an embodiment of a scheduling method for scheduling interaction with a subject.

### DETAILED DESCRIPTION OF EMBODIMENTS

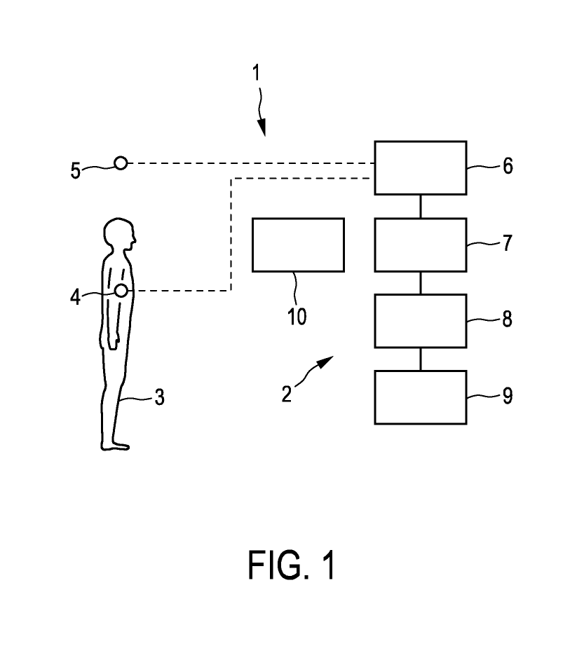

FIG. 1 shows schematically and exemplarily an embodiment of an interaction system 1 for interacting with a subject 3, which, in this example, is a patient, in particular, a patient having a chronic medical condition. The interaction system 1 comprises a scheduling system 2 for scheduling interaction with the patient 3, and an interaction sub-system 10 for interacting with the patient 3. The interaction system 1 may be used, for instance, by a medical caregiver, such as a medical doctor, a nurse or a pharmacist, who would like to interact with the patient 3.

In this embodiment, the scheduling system 2 comprises one or more sensors 4, 5 for acquiring sensor data, wherein the sensor data are indicative of a situation of the patient 3. The one or more sensors 4, 5 comprise one or more, here, two biometric sensors 4 (not shown separately in the figure) for acquiring biometric data of the patient 3 and one or more, here, three, environmental sensors 5 (also not shown separately in the figure) for acquiring environmental data of an environment of the patient 3. The scheduling system 2 further comprises a receiving unit 6 adapted to receive the sensor data acquired by the one or more sensors 4, 5, an analyzing unit 7 adapted to analyze the received sensor data for a past period of time to detect recurring patterns in the situation of the patient 3 during the past period of time, a predicting unit 8 adapted to predict the situation of the patient 3 during a future period of time based on the received sensor data for a current period of time and the detected recurring patterns, and a scheduling unit 9 adapted to generate a schedule for interacting with the patient 3 based on the predicted situation. Since the scheduling unit 9 utilizes the predicted situation to generate a schedule for interacting with the patient 3, it is possible for the scheduling unit 9 to identify opportune moments for interactions.

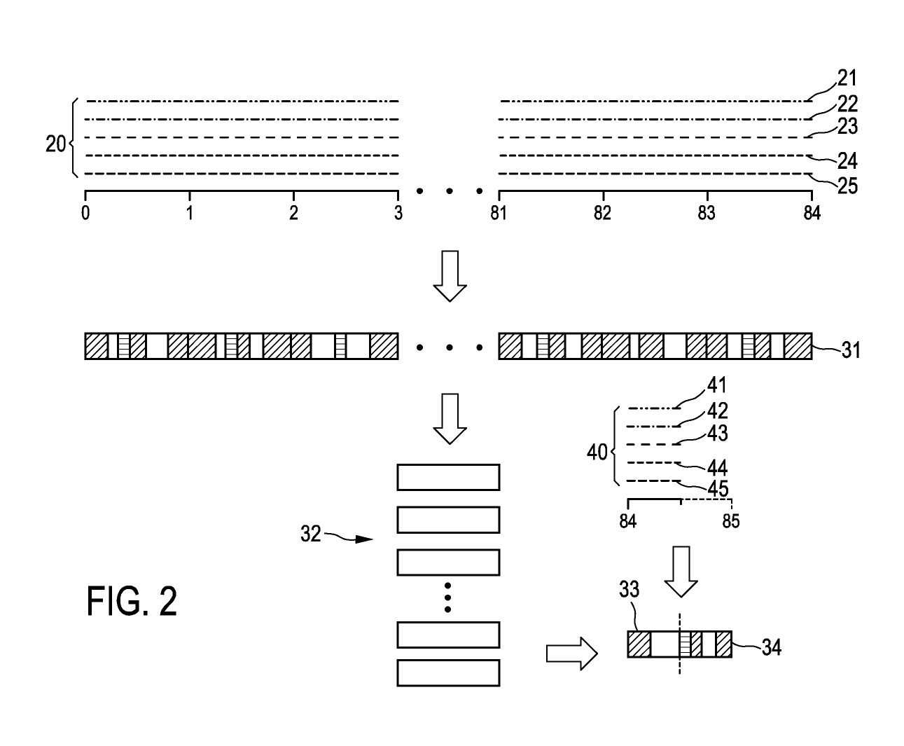

In this example, the analyzing unit 7 is adapted to detect the recurring patterns based on eigensituations derived from the received sensor data for the past period of time. Moreover, the analyzing unit 7 is adapted to represent the situation of the patient 3 by a readiness measure which indicates a readiness of the patient 3 to process information at a given time. These aspects will be described in more detail with reference to FIG. 2, which shows schematically and exemplarily a processing by the analyzing unit 7 and the predicting unit 8 using an eigensituation analysis.

Here, the past period of time for which the sensor data 20 acquired by the two biometric sensors 4 and the three environmental sensors 5 have been received is 12 weeks (in the figure labelled as days 0 to 83). The biometric data comprise data 21 indicative of an activity level of the patient 3 and data 22 indicative of a relaxation level of the patient 3, and the environmental data comprise data 23 indicative of a location of the patient 3, data 24 indicative of an air quality in the environment of the patient 3 and data 25 indicative of a presence of persons nearby the patient 3. The sensor data are acquired by means of an accelerometer (activity level), which acquires an acceleration of the patient 3, a heart rate monitor (relaxation level), which acquires a heart rate of the patient 3, a GPS sensor (location), which acquires the location of the patient 3, a CO₂ sensor (air quality), which acquires an amount of CO₂ in the environment of the patient 3, and a Bluetooth device (presence of persons nearby the patient), which acquires a presence of Bluetooth devices nearby the patient 3. The received sensor data 20 for the past period of time are further processed, for instance, classified or the like. In this example, the activity level of the patient 3 is determined from the acquired acceleration, wherein the determined activity level is classified into three classes, i.e., <low activity level>, <medium activity level>, <high activity level>. Likewise, the relaxation level, the location, the air quality and the presence of persons nearby the patient 3 are determined from the acquired sensor data, respectively, and the determined parameters are classified into a number of classes. Here, suitable classes are chosen as: <low relaxation level>, <medium relaxation level>, <high relaxation level> for the relaxation level; <indoor>, <outdoor> for the location; <good air quality>, <medium air quality>, <high air quality> for the air quality; <no persons present>, <persons present> for the presence of persons nearby the patient 3. It shall be noted that in addition to the sensor data additional information, for example, predetermined knowledge about the patient 3, can be used for determining the different parameters. For instance, in order to determine the location of the patient 3, in addition to the location acquired by the GPS sensor, predetermined knowledge about the location of the patient's home and/or the patient's workplace can be used for determining whether the patient 3 is located indoor or outdoor at a given time.

In this example, the determined activity level, relaxation level, location, air quality and presence of persons nearby the patient 3 are used by the analyzing unit 7 to reliably determine the readiness measure 31 for the past period of time, i.e., the 12 weeks for which the acquired sensor data 20 have been received. In one preferred realization, the determined parameters are combined in a sum or a weighted sum to determine the readiness measure 31 for the past period of time. In more detail, different scores are given to the respective classes of the different parameters and, for a given time during the past period of time, the readiness measure 31 is determined by summing the scores for the sensor data 20 (i.e., activity level, relaxation level, location, air quality and presence of persons nearby the patient 3) for the given time. In this approach, the scores are suitably chosen such that parameters that are considered to have a stronger influence on the patient's readiness to process information are generally given larger scores than parameters that are considered to have a weaker influence. The scores can be chosen, for example, such that a higher readiness measure indicates a higher readiness of the patient to process information, whereas a lower readiness measure indicates a lower readiness of the patient to process information. In this example, the readiness measure is further classified based on the sum of the scores into three classes, i.e., <low readiness>, <medium readiness>, <high readiness>.

In this embodiment, the analyzing unit 7 is adapted to detect the recurring patterns 32 in the readiness measure 31 for the past period of time, wherein the predicting unit 8 is adapted to predict the readiness measure 34 for the future period of time based on the received sensor data 40 for the current period of time and the detected recurring patterns 32. In more detail, an eigensituation analysis is performed on the readiness measure 31 for the past period of time in order to determine the eigensituations, i.e., the set of characteristic vectors that span the ‘situational space’, which characterize the situation variation, here, the variation in the readiness of the patient 3 to process information, during the past period of time. The analysis is performed, here, in units of days, i.e., the eigensituations characterize the daily variation in the readiness of the patient 3 to process information during the past period of time. The strongest or primary eigensituations correspond to the recurring patterns 32 in the daily situation (i.e., the daily readiness to process information) of the patient 3 during the past period of time (see Nathan Eagle and Alex Sandy Pentland, “Eigenbehaviors: identifying structure in routine”, in Behavioral Ecology and Sociobiology, Vol. 63, No. 11, pages 1057 to 1066, April 2009). The recurring patterns 32 can be used to “analyze” the received sensor data 40 for the current period of time and to predict the readiness measure 34 for the future period of time. The current period of time for which the sensor data 40 acquired by the two biometric sensors 4 and the three environmental sensors 5 are received corresponds to a first part of a present day (in the figure labelled as day 84), here, the first half of the present day, i.e., from 12 am to 12 pm, and the future period of time corresponds to a later part of the present day, here, the second half of the present day, i.e., from 12 pm to 12 am. As described above, the biometric data comprise the data 41 indicative of the activity level of the patient 3 and the data 42 indicative of the relaxation level of the patient 3, and the environmental data comprise the data 43 indicative of the location of the patient 3, the data 44 indicative of the air quality in the environment of the patient 3, and the data 45 indicative of the presence of persons nearby the patient 3. In this example, the received sensor data 40 for the current period of time are further processed, for instance, classified or the like, as described above, in order for the analyzing unit 7 to determine the activity level of the patient 3, the relaxation level of the patient 3, the location of the patient 3, the air quality in the environment of the patient 3 and the presence of persons nearby the patient 3, wherein these parameters are then used to reliably determine the readiness measure 33 for the first half of the present day. By calculating the weights for the recurring patterns 32 such that their weighted sum suitably represents the readiness measure 33 for the first half of the present day, the readiness measure 34 for the second half of the present day can then be predicted.

The scheduling unit 9, here, is adapted to generate the schedule based on the predicted readiness measure 34 for the future period of time, here, the second half of the present day. For instance, an interaction with the patient 3 is scheduled for a time during the second half of the present day for which the predicted readiness measure 34 assumes a <high readiness>.

With returning reference to FIG. 1, the interaction sub-system 10 comprises a system for performing a video conversation with the patient 3. This allows for a direct, personal contact with, for instance, a medical caregiver, such as a medical doctor, a nurse or a pharmacist. In addition or alternatively, the interaction sub-system 10 can comprise a system for presenting media content to the patient 3. The media content can comprise moving picture content and/or still picture content and/or audio content and/or text content. This allows for the presentation of educational media content, for instance, media content which illustrates how certain exercises that may improve or at least stabilize a medical condition of the patient 3 should be performed, media content which illustrates how a medication should be taken, et cetera, to the patient 3.

In this embodiment, the interaction sub-system 10 is adapted to send a message to the patient 3 for prompting the patient 3 to engage in an interaction. It has been found that the opportunity for interacting efficiently with a patient 3, in particular, a patient is quite limited. Prompting the patient 3 to engage in an interaction, for instance, to watch or hear educational media content or to take part in a video conversation with a medical caregiver, is an effective way to engage the patient 3.

If the interaction sub-system 10 comprises a system for presenting media content to the patient 3, it is preferably adapted to automatically initiate an interaction with the patient 3 according to the generated schedule. Therewith, an automatic interaction sub-system 10 can be realized which initiates an interaction with the patient 3 at an opportune moment without requiring a medical caregiver to initiate and perform an interaction.

The interaction sub-system 10 can be adapted to allow the patient 3 to refuse the initiated interaction, wherein the interaction sub-system 10 is further adapted to automatically re-initiate an interaction with the patient 3 at a later time according to the generated schedule. This takes into consideration that in some cases, the moment at which an interaction is initiated according to the generated schedule may indeed not be a good moment for interacting with the patient 3, for instance, because the readiness of the patient 3 to process information on the present day strongly deviates from his/her “recurring situations”. In this case, the possibility of interacting with the patient 3 must not be completely missed, but it can be tried again to initiate an interaction with the patient 3 at a later time according to the generated schedule.

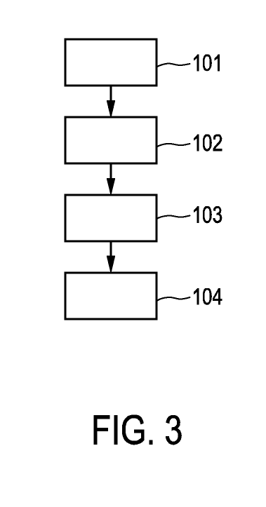

In the following, an embodiment of a scheduling method for scheduling interaction with a subject 3, which, in this example, is a patient, in particular, a patient having a chronic medical condition, will be exemplarily described with reference to a flowchart shown in FIG. 3. The scheduling method can be performed, for instance, with the scheduling system 2 described with reference to FIG. 1.

In step 101, sensor data acquired by one or more sensors 4, 5 are received, by a receiving unit 6, wherein the sensor data are indicative of a situation of the patient 3. In step 102, the received sensor data for a past period of time are analyzed to detect recurring patterns in the situation of the patient 3, by an analyzing unit 7. In step 103, the situation of the patient 3 during a future period of time is predicted based on the received sensor data for a current period of time and the detected recurring patterns, by a predicting unit 8. In step 104, a schedule is generated for interacting with the patient 3 based on the predicted situation, by a scheduling unit 9.

The scheduling method can be part of an interaction method for interacting with the subject 3, which, in this example, may be a patient, in particular, a patient having a chronic medical condition, wherein this method may comprise an additional step of interacting with the patient 3, by an interaction sub-system 10. The interaction method can be performed, for instance, with the interaction system 1 described with reference to FIG. 1.

The present invention also relates to a scheduling computer program for scheduling interaction with a subject. The scheduling computer program can also be a part of an interaction computer program for interacting with the subject.

It shall be noted that in the embodiment of the interacting system described with reference to Fig.1 above, the analyzing unit 7 can be adapted to update the detection of the recurring patterns when additional sensor data for a more recent period of time compared to the past period of time have been received. This allows the analyzing unit 7 to make use of as much received sensor data as possible for detecting the recurring patterns, which will result in an improved detection, in particular, of smaller and less frequently occurring patterns, over time.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Operations like the analyzing of received sensor data for a past period of time to detect recurring patterns in the situation of the subject, the predicting of the situation of the subject during a future period of time based on received sensor data for a current period of time and the detected recurring patterns, and the generating of a schedule for interacting with the subject based on the predicted situation, et cetera, performed by one or several units or devices can be performed by any other number of units or devices. For instance, the analyzing unit can be integrated with the predicting unit into a single unit or device.

The operations and/or the control of the scheduling apparatus in accordance with the scheduling method may be implemented as program code of a computer program and/or as dedicated hardware. The computer program may be stored/distributed on a suitable sub-system, such as an optical storage sub-system or a solid-state sub-system, supplied together with or as part of other hardware, but may also be distributed in other forms, such as via the Internet or other wired or wireless telecommunication systems.

Any reference signs in the claims should not be construed as limiting the scope.

The invention relates to a scheduling system for scheduling interaction with a subject. A receiving unit receives sensor data acquired by one or more sensors, wherein the sensor data are indicative of a situation of the subject. An analyzing unit analyses the received sensor data for a past period of time to detect recurring patterns in the situation of the subject during the past period of time. A predicting unit predicts the situation of the subject during a future period of time based on received sensor data for a current period of time and the detected recurring patterns. A scheduling unit generates a schedule for interacting with the subject based on the predicted situation. Since the scheduling unit utilizes the predicted situation to generate a schedule for interacting with the subject, it is possible for the scheduling unit to identify opportune moments for interactions.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A scheduling system for scheduling interaction with a subject wherein the scheduling system comprises:
a receiving unit adapted to receive sensor data acquired by one or more sensors wherein the sensor data are indicative of a situation of the subject,
an analyzing unit adapted to analyze the received sensor data for a past period of time to detect recurring patterns in the situation of the subject during the past period of time,
a predicting unit adapted to predict the situation of the subject during a future period of time based on the received sensor data for a current period of time and the detected recurring patterns and
a scheduling unit adapted to generate a schedule for interacting with the subject based on the predicted situation,
wherein the analyzing unit is adapted to represent the situation of the subject by a readiness measure which indicates a readiness of the subject to process information at a given time, wherein the analyzing unit is adapted to determine the readiness measure for the past period of time based on the received sensor data for the past period of time and to detect the recurring patterns in the readiness measure for the past period of time, wherein the predicting unit is adapted to predict the readiness measure for the future period of time based on the received sensor data for the current period of time and the detected recurring patterns.

2. The scheduling system as defined in claim 1, wherein the analyzing unit is adapted to detect the recurring patterns based on eigensituations derived from the received sensor data for the past period of time, wherein the eigensituations characterize the situational variation during the past period of time.

3. The scheduling system as defined in claim 1, wherein the sensor data comprise biometric data of the subject acquired by one or more biometric sensors ti) and environmental data of an environment of the subject acquired by one or more environmental sensors wherein the readiness measure -for the past period of time is determined from the received biometric data for the past period of time and the received environmental data for the past period of time.

4. The scheduling system as defined in claim 1, wherein the scheduling unit is adapted to generate the schedule based on the predicted readiness measure for the future period of time.

5. The scheduling system as defined in claim 1, wherein the current period of time corresponds to a first part of a present day and the future period of time corresponds to a later part of the present day.

6. The scheduling system as defined in claim 1, wherein the analyzing unit ki4is adapted to update the detection of the recurring patterns when additional sensor data for a more recent period of time compared to the past period of time have been received.

7. An interaction system for interacting with a subject , wherein the interaction system comprises:
the scheduling system as defined in claim 1, and an interaction sub-system for interacting with the subject.

8. The interaction system as defined in claim 7, wherein the interaction sub-system comprises a system for performing a video conversation with the subject and/or a system for presenting media content to the subject.

9. The interaction system as defined in claim 7, wherein the interaction sub-system is adapted to send a message to the subject for prompting the subject to engage in the interaction.

10. The interaction system as defined in claim 7, wherein the interaction sub-system is adapted to automatically initiate an interaction with the subject according to the generated schedule.

11. The interaction system as defined in claim 10, wherein the interaction sub-system is adapted to allow the subject to refuse the initiated interaction, wherein the interaction sub-system is further adapted to automatically re-initiate an interaction with the subject at a later time according to the generated schedule.

12. A computer-implemented scheduling method for scheduling interaction with a subject, wherein the scheduling method comprises:
receiving sensor data acquired by one or more sensors, by a receiving unite wherein the sensor data are indicative of a situation of the subject,
analyzing the received sensor data for a past period of time to detect recurring patterns in the situation of the subject during the past period of time, by an analyzing unit,
predicting the situation of the subject during a future period of time based on the received sensor data for a current period of time and the detected recurring patterns, by a predicting unit, and
generating a schedule for interacting with the subject based on the predicted situation, by a scheduling unit,
wherein the analyzing unit represents the situation of the subject by a readiness measure which indicates a readiness of the subject to process information at a given time, wherein the analyzing unit determines the readiness measure for the past period of time based on the received sensor data for the past period of time and to detect the recurring patterns in the readiness measure for the past period of time, wherein the predicting unit predicts the readiness measure for the future period of time based on the received sensor data for the current period of time and the detected recurring patterns.

13. A scheduling computer program for scheduling interaction with a subject, wherein the scheduling computer program comprises program code means for causing a scheduling system to carry out the steps of the scheduling method as defined in claim 12, when the scheduling computer program is run on a computer controlling the scheduling system.
